(19) United States
(12) Patent Application Publication
(10) Pub. No.: US 2019/0239432 A1
(43) Pub. Date: Aug. 8, 2019

(54) HYDRAULIC-POWERED FRUIT TREE HARVESTING VEHICLE

(71) Applicant: Ferrell Deen, Wapto, WA (US)

(72) Inventor: Ferrell Deen, Wapto, WA (US)

(21) Appl. No.: 15/889,263

(22) Filed: Feb. 6, 2018

(51) Int. Cl. A01D 46/253; A01D 46/20; A01D 46/24; B60K 5/08; B60P 1/02

(52) U.S. Cl. CPC A01D 46/253; A01D 46/20; B60P 1/02; B60K 5/08; A01D 46/243

(57) ABSTRACT

A fruit harvesting vehicle comprising a hydraulic power system comprising a plurality of hydraulic motors and hydraulic cylinders. At least a pair of elevating work platforms, with an equal number positioned in opposition on each side of the vehicle, with each elevating work platform operated by independent hydraulic cylinders to raise and lower. A front chain drive system powered by a first hydraulic motor transporting an empty harvest bin from a front deck into a filling position to interface with a rotating hydraulic driven bin filler system. A rear chain drive system powered by a second hydraulic motor transporting a filled harvest bin onto a rear deck. A fill sensor associated with a harvest bin interfaced with the rotating hydraulic driven bin filler system to lower in place over the associated harvest bin. The fill sensor automatically raises the rotating hydraulic driven bin filler system and operates the chain drive systems.

### CROSS-REFERENCE TO RELATED APPLICATION(S)

Not applicable.

### BACKGROUND OF THE INVENTION

### 1. Field of Invention

The present invention relates to the field of agriculture machinery, more particularly to a hydraulic powered fruit tree picker/harvesting vehicle.

### 2. Description of Related Art

Fruit tree harvesting poses considerable challenges for orchard owners. Harvesting ripe fruit requires considerably labor to pick ripe fruit, which must be picked/harvested within a short time frame once the fruit ripens. Traditionally, this requires large numbers of pickers manually moving step ladders of varying height from tree-to-tree, climbing the ladder to pick fruit on higher branches, filling small fruit bins, and carrying the small fruit bins to a harvesting trailer or truck to transport back to a processing shed.

In recent years, more efficient processes have been interjected into the harvesting process including machines. For the most part, the machines introduced seek to shake fruit trees to dislodge ripened fruit and/or large vacuuming machines designed to collect fallen fruit from the ground. Elevating machines have also been introduced with an enclosed picker platform for elevating to enable picking ripe fruit on the upper part of the tree, and some of these machines further incorporate an air hose system for receiving picked fruit and using a vacuum to transport the fruit into a collection bin integrated in the vehicle structure.

These machine still exhibit various drawbacks. Shaking fruit trees will dislodge both ripe and unripe fruit. Picker platforms still require a support vehicle for receiving bins of picked fruit and only generally only accommodate a single picker on a single row of fruit trees.

Based on the foregoing, there is a need in the art for a new harvesting machine integrating a plurality of picking platforms with a hose system feeding harvested fruit into large bin for transport to a processing building.

### SUMMARY OF THE INVENTION

A fruit harvesting vehicle comprising a vehicle chassis having a front end, a rear end, a right side, and a left side. A hydraulic power system comprises a one cylinder diesel engine powered hydraulic pump powering a plurality of hydraulic motors and hydraulic cylinders. At least a pair of elevating work platforms, with an equal number positioned in opposition on each side of the vehicle, with each elevating work platform operated by independent hydraulic cylinders to raise and lower the elevating work platforms. A front chain drive system powered by a first hydraulic motor for transporting an empty harvest bin from a front deck into a filling position to interface with a lowered rotating hydraulic driven bin filler system, and a rear chain drive system powered by a second hydraulic motor for transporting a filled harvest bin onto a rear deck from the filling position. A fill sensor associated with a harvest bin interfaced with the rotating hydraulic driven bin filler system lowered in place over the associated harvest bin, said fill sensor automatically raising the rotating hydraulic driven bin filler system and operating the front chain drive system and the rear chain drive system to transport the filled harvest bin onto the rear deck and the empty harvest bin into the filling position and further to lower the rotating hydraulic driven bin filler system into place and interface with the empty harvest bin.

The fruit harvesting machine further comprises a pair of drive wheels on the rear end comprised of a first drive wheel powered by a third hydraulic motor and a second drive wheel powered by a fourth hydraulic motor, and a pair of steerable front wheels on the front end steered by a first hydraulic cylinder.

The fruit harvesting machine further comprises a fifth hydraulic motor powering the rotating hydraulic driven bin filler system.

The hydraulic pump generates about 3500 psi.

The hydraulic pump operates at aboutl2 gallons a minute.

The vehicle further comprises a front fork at the front end and a rear fork at the rear end, said forks configured to respectively handle movement of the harvest bin on and off the vehicle.

The front deck and the rear deck includes a set of recessed tracks to accommodate the chain drive systems.

The fill sensor comprises a volume or weight sensor.

The harvest bin comprises the fill sensor.

The rotating hydraulic driven bin filler system comprises the fill sensor.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a stylized top view of the major components of a harvesting vehicle, according to an embodiment of the present invention.

### DETAILED DESCRIPTION OF PREFERRED EMBODIMENTS

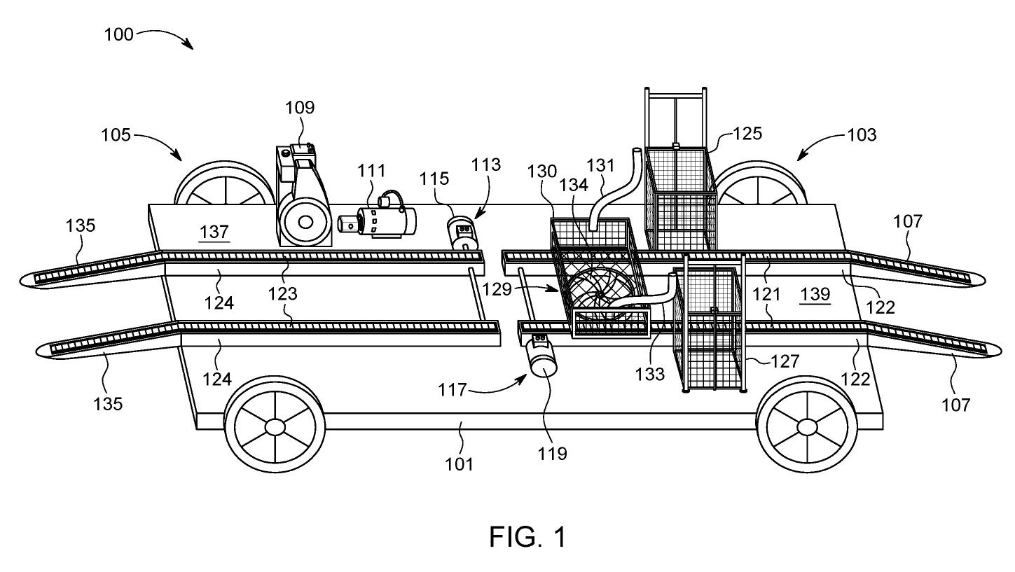

Preferred embodiments of the present invention and their advantages may be understood by referring to FIG. 1, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows a stylized top view of the harvesting vehicle 100 depicting the major components. Vehicle 100 includes a chassis 101 approximately 18 feet long and 7 feet wide. Steerable front wheels 103 can be used to direct the travel path of the vehicle 100. Rear wheels 105 can provide motive power from a one cylinder diesel engine 109 powering a hydraulic motor on each rear wheel 105. Both sets of wheels 103 and 105 can comprise 10″ low profile tires, and further can be connected to the chassis 101 by an elevation system, such as a set of hydraulic scissoring frames, that can elevate the chassis 101 up to five feet vertically. The two front tires can be turned by hydraulic rams, and all four tires can be on independent suspensions.

A set of forks 107 at the front of chassis 101 can interface with a large bin to lift the bin onto the chassis 101. A one cylinder diesel engine 109 can power a hydraulic pump 111. Hydraulic pump 111 can in turn provide power to a rear chain drive system 113 comprised of a hydraulic motor 115 and a set of rear drive chains 123 in a set of recessed tracks 124. Hydraulic pump 111 can also provide power to a front chain drive system 117 comprised of a hydraulic motor 119 and a set of front drive chains 121 in a set of recessed tracks 122. The hydraulic pump 111 provides hydraulic pressure and fluid flow to the pair of hydraulic motors 115 and 119.

The hydraulic system powered by the hydraulic pump 111 also provides hydraulic power to a pair of elevating work platforms 125 and 127. Work platform 125 can be positioned on the right side of the chassis 101 and work platform 127 can be positioned on the left side of chassis 101. The elevating work platforms 125 and 127 can include a safety cage or bucket to keep a picker from falling as well as about a three foot elevating height. Together with the elevating frame, the vehicle 100 can elevate up to about 8 feet, with a maximum safe harvesting height of between about 12 feet and 14 feet (counting the height and reach of a picker).

A rotating hydraulic driven bin filler system 129 can comprise a fan 134 to create a low pressure vacuuming system in concert with tubes 131 and 133. Tube 131 can be integrated with work platform 125 and tube 133 can be integrated with work platform 127. Picked fruit can be placed into tubes 131 and 133 and a generated low pressure vacuum can facilitate passage of the harvested fruit down the tube and into harvest bin 130. Harvest bin 130 can interface with rotating hydraulic driven bin filler system 129 to deposit harvested fruit gently into harvest bin 130.

In an embodiment, the front chains 121 can transport harvest bins 130 on the front deck 139 into position to interface with rotating hydraulic driven bin filler system 129. Once full, the rear chains 123 can transport harvest bins onto the rear deck 137 and move them back to rear forks 135. Rear forks 135 can be used to lower and discharge harvest bins 130 from rear deck 137. Both the front forks 105 and rear forks 135 use a hydraulic ram to raise or lower.

In an embodiment, the work platforms 125 and 127 can be operated by foot actuated hydraulic controls. The harvest bins 130 can comprise a fill sensor system based on weight or volume to indicate full and empty condition. When the harvest bin 130 reaches its full condition, a volume or weight sensor causes rotating hydraulic driven bin filler system 129 to raise from the harvest bin 130, activating an automated system to move the full harvest bin 130 back onto rear deck 137 and an empty harvest bin 130 into position to interface with rotating hydraulic driven bin filler system 129. In an alternate embodiment, the fill sensor can be integrated into the rotating hydraulic driven bin filler system.

In an embodiment, the hydraulic system on vehicle 100 can be powered by a single one cylinder diesel engine 109 running a hydraulic pump 111 operating at 12 gallons per a minute at 3500 psi maximum pressure. Five hydraulic motors can be run off the hydraulic system with two motors driving the vehicle 100, two motors running front chain system 121 and rear chain system 123, and one motor powering the rotating hydraulic driven bin filler system 129. Five hydraulic cylinders can also be run off the hydraulic system with two on forks 105 and 135, two on the elevating work platforms 125 and 127, and one used to steer the front wheels 103.

In an embodiment, five people can operate harvesting vehicle 100, with two ground pickers picking fruit, two elevated platform pickers picking fruit, and one person operating and controlling the vehicle 100. Further, the vehicle 100 can support picking operations on two rows; one on each side of the vehicle.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A fruit harvesting vehicle comprising:
a vehicle chassis having a front end, a rear end, a right side, and a left side;
a hydraulic power system comprising a one cylinder diesel engine powered hydraulic pump powering a plurality of hydraulic motors and hydraulic cylinders;
at least a pair of elevating work platforms, with an equal number positioned in opposition on each side of the vehicle, with each elevating work platform operated by independent hydraulic cylinders to raise and lower the elevating work platforms;
a front chain drive system powered by a first hydraulic motor for transporting an empty harvest bin from a front deck into a filling position to interface with a lowered rotating hydraulic driven bin filler system, and a rear chain drive system powered by a second hydraulic motor for transporting a filled harvest bin onto a rear deck from the filling position; and
a fill sensor associated with a harvest bin interfaced with the rotating hydraulic driven bin filler system lowered in place over the associated harvest bin, said fill sensor automatically raising the rotating hydraulic driven bin filler system and operating the front chain drive system and the rear chain drive system to transport the filled harvest bin onto the rear deck and the empty harvest bin into the filling position and further to lower the rotating hydraulic driven bin filler system into place and interface with the empty harvest bin.

2. The fruit harvesting machine of claim 1, further comprising:
a pair of drive wheels on the rear end comprised of a first drive wheel powered by a third hydraulic motor and a second drive wheel powered by a fourth hydraulic motor; and
a pair of steerable front wheels on the front end steered by a first hydraulic cylinder.

3. The fruit harvesting machine of claim 1, further comprising a fifth hydraulic motor powering the rotating hydraulic driven bin filler system.

4. The fruit harvesting machine of claim 1, wherein the hydraulic pump generates about 3500 psi.

5. The fruit harvesting machine of claim 1, wherein the hydraulic pump operates at aboutl2 gallons a minute.

6. The fruit harvesting machine of claim 1, wherein the vehicle further comprises a front fork at the front end and a rear fork at the rear end, said forks configured to respectively handle movement of the harvest bin on and off the vehicle.

7. The fruit harvesting machine of claim 1, wherein the front deck and the rear deck includes a set of recessed tracks to accommodate the chain drive systems.

8. The fruit harvesting machine of claim 1, wherein the fill sensor comprises a volume or weight sensor.

9. The fruit harvesting machine of claim 1, wherein the harvest bin comprises the fill sensor.

10. The fruit harvesting machine of claim 1, wherein the rotating hydraulic driven bin filler system comprises the fill sensor.
